(19) United States
(12) Patent Application Publication
(10) Pub. No.: US 2002/0054451 A1
(43) Pub. Date: May 9, 2002

(54) VCM head position detection and control with back EMF

(76) Inventors: Myung Soo Moon, Longmont, CO (US); Lee Dizaji, Louisville, CO (US); Fadi Youssef Abou-Jaoude, Arvada, CO (US); Sanghoon Lee, Longmont, CO (US)

Correspondence Address: MERCHANT & GOULD PC, P.O. BOX 2903, MINNEAPOLIS, MN, 55402-0903, US

(21) Appl. No.: 09/894,247

(22) Filed: Jun. 27, 2001

Related U.S. Application Data
(60) Provisional application No. 60/246,167, filed on Nov. 6, 2000.

(51) Int. Cl. G11B 5/596

(52) U.S. Cl. 360/78.06; 360/78.07; 360/78.11

(57) ABSTRACT

A method and apparatus for estimating position and speed of a read/write head in a disc drive, based upon the back EMF of the voice coil motor involves estimating the voltage across the voice coil motor and estimating the voltage across a current-sensor resistor in the voice coil circuit, preferably with a differential amplifier. Further, a coil resistance voltage is estimated by measuring the voltage across the current-sensor resistor with a differential amplifier and amplifying the voltage across the current-sensor resistor by a gain value. Finally, the combined voltage across the current-sensor resistor and the characteristic coil resistance is subtracted from the voltage across the voice coil motor, yielding the back EMF of the voice coil motor. The back EMF is representative of head velocity which may be integrated to yield position. Accordingly, the back EMF can be used to control the speed and position of the read/write head.

### RELATED APPLICATIONS

This application claims the benefit of the filing date of U.S. Provisional Patent Application Ser. No. 60/246,167 filed Nov. 6, 2000 and entitled “VCM HEAD POSITION DETECTION AND CONTROL WITH BACK EMF.”

### FIELD OF THE INVENTION

This application relates to hard disc drives and more particularly to an apparatus and method for determining the speed or position of a read/write head in a disc drive based upon knowledge of the level of back EMF in the voice coil motor.

### BACKGROUND OF THE INVENTION

The storage medium for a disc drive is a flat, circular disc capable of retaining localized magnetic fields. The data that are stored upon the disc find physical representation through these localized magnetic fields. The data are arranged on the disc in concentric, circular paths known as tracks.

The localized magnetic fields can be detected by a magnetically sensitive head when they are brought in close proximity to the head. During operation the disc continually rotates, meaning that for each rotation, a head fixed a given radius from the center of the disc would encounter every localized magnetic field along a given track. Altering the radial coordinate of the head allows the head to read or write data along a different track.

The head is mounted upon an actuator arm that is rotated by a servo control system. Accordingly, the track position of the head is controlled by the servo system. When the head needs to access a different track, the actuator arm is rotated under the control of the servo control system, bringing the head to the desired track position.

In a conventional disc drive, the servo control system operates based upon a feedback loop. A reference signal (which represents a target head velocity) is provided to the servo control system. The reference signal is determined by the distance between the head and its desired track location. The reference signal serves as an electrical impetus to excite a voice coil motor and thereby drive the head toward its destination track. As the head slews across the surface of the disc, the servo control system determines the head's track location and velocity or speed by reading track location information contained within servo wedges, which are interspersed throughout each track. Based upon the difference between the desired track location and velocity of the head and its measured track location and velocity, the control system determines a new signal with which to drive the voice coil motor. Under this form of control, the head is driven until it comes to rest over its destination track.

When a disk drive has no power and is not in operation, the read/write head is either parked in a landing zone that is located at the inner diameter of the disk or on a ramp located adjacent to the outer diameter of the disk. During power-up the read/write head must move toward a median track location, located between the inner and outer diameter of the disc. During this period, the servo control system is unable to accurately determine the track position or velocity of the read/write head by reading the servo wedges, because the servo control system has not yet locked the read/write head over a track to permit reading of the servo wedges. Thus, during periods such as power-up (when the servo wedges are unreadable), the servo control system is unable to operate in its normal manner. The consequence of the unavailability of the servo wedges during power-up is that either costly additional hardware is required to provide the servo control system with track location and head velocity information or that an unreliable open loop current/voltage drive method is utilized. Therefore, a need exists for a method and apparatus that provides the servo control system of a typical disc drive with track location and head velocity information during periods such as power-up, doing so with minimal additional hardware.

### SUMMARY OF THE INVENTION

A method and apparatus in accordance with one embodiment of the present invention solves the aforementioned problems and other problems. The method involves estimating the voltage across the voice coil motor, a voltage across a current-sensor resistor, and a voice coil resistance voltage. The combined voltage across the current-sensor resistor and the coil resistance voltage is subtracted from the voltage across the voice coil motor, yielding the back EMF of the voice coil motor. The back EMF is indicative of the speed or velocity and position of the read/write head and is used to allow velocity and positional control without the embedded servo sector information.

Another embodiment of the present invention involves a current sensor resistor electrically coupled in series with the voice coil motor coil. A first differential amplifier is configured and arranged to amplify the voltage across the voice coil motor, thereby yielding a voice coil motor voltage. The first differential amplifier provides the voice coil motor voltage to a first summer. A second differential amplifier is configured and arranged to amplify a voltage across the current sensor resistor, thereby yielding a current sensor resistor voltage. The second differential amplifier provides the current sensor resistor voltage to a coil resistance estimator amplifier. The coil resistance estimator amplifier is configured and arranged to receive the current sensor resistor voltage and to produce an estimate of the coil resistance voltage added to the current sensor resistor voltage. The coil resistance estimator amplifier provides the estimate of the coil resistance voltage added to the current sensor resistor voltage to the first summer. Finally, the first summer receives the voice coil motor voltage and the estimate of the coil resistance voltage added to the current sensor resistor voltage. The first summer then determines the back electromotive force across the voice coil motor by finding the difference between the voice coil motor voltage and the estimate of the coil resistance voltage added to the current sensor resistor voltage, the summer thereby emitting a back electromotive force signal. The back electromotive force signal is approximately proportional to head velocity, and the time integration of the velocity is approximately equal to position of the head. Accordingly, the back electromotive force signal may be used in a feedback loop to control head position and speed.

These and various other features as well as advantages which characterize the present invention will be apparent from a reading of the following detailed description and a review of the associated drawings.

### BRIEF DESCRIPTION OF THE DRAWINGS

FIG. 1 is a simplified block diagram of a disc drive in which an embodiment of the present invention is used.

FIG. 2 depicts a model of the voice coil motor, accounting for back EMF due to the motion of the coil.

FIG. 3 is a signal flow diagram depicting the steps by which a disc drive may be controlled, using the back EMF of its voice coil motor as the basis for determining head velocity and head position.

FIG. 4 depicts an embodiment of a control system in accordance with the present invention.

### DETAILED DESCRIPTION

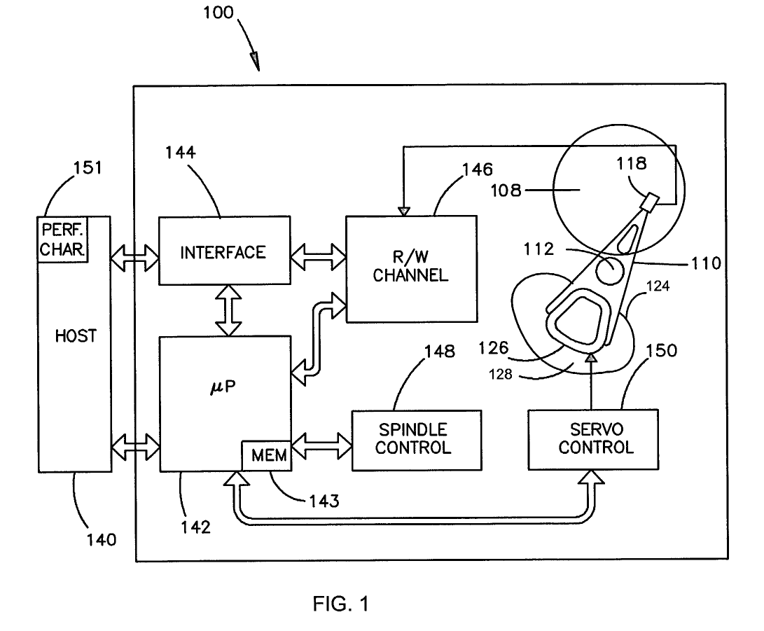

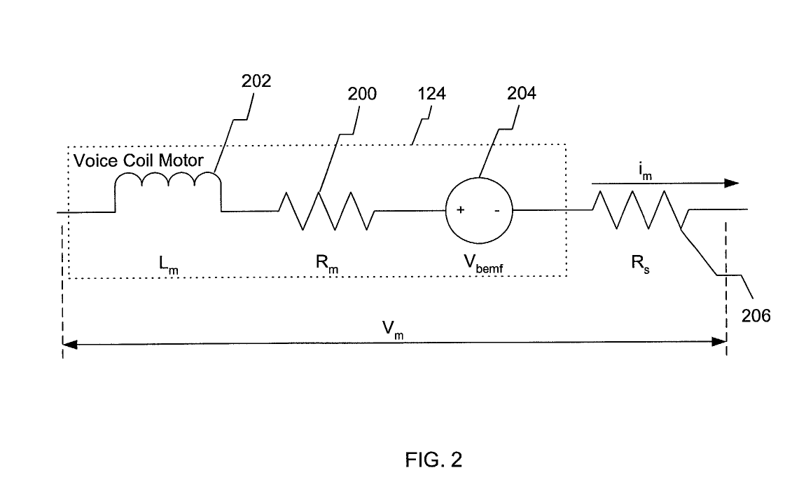

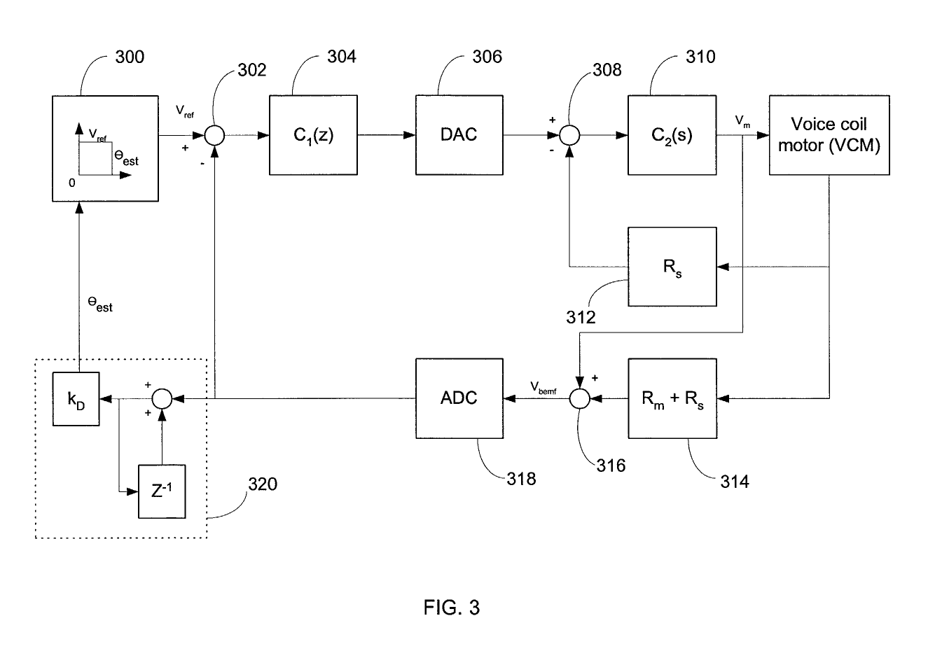

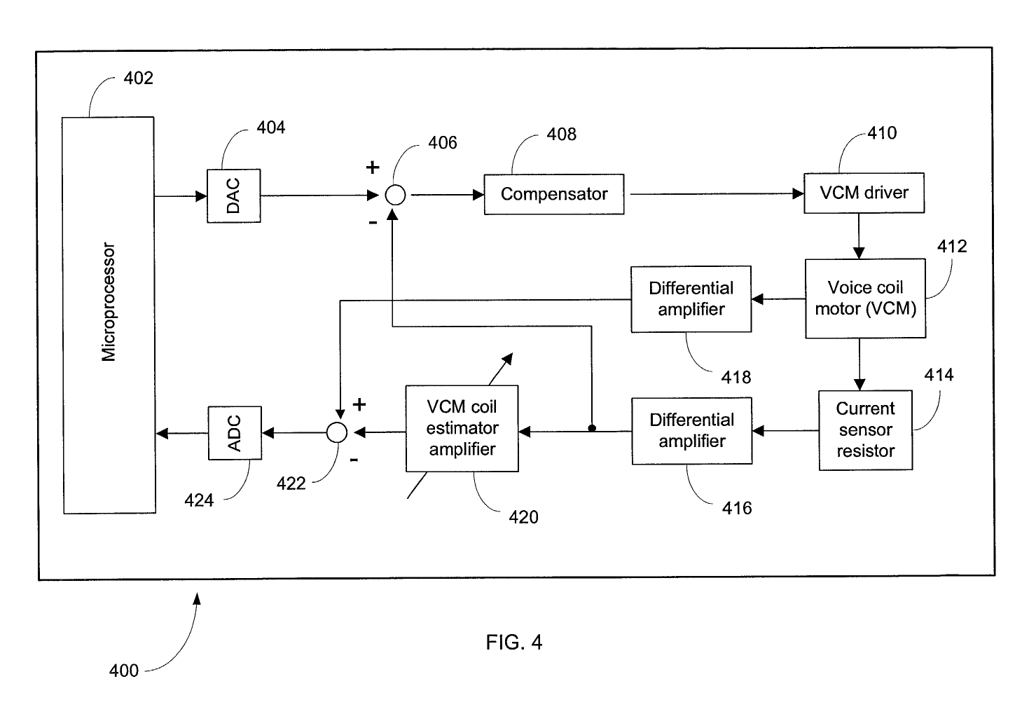

In the following detailed description, the discussion associated with FIG. 1 is intended to familiarize the reader with the major functional components of a disc drive. The discussion associated with FIG. 2 provides context allowing the reader to understand the principle upon which one embodiment of the invention is founded. Finally, FIGS. 3 and 4 are directed to embodiments of the invention itself.

A disc drive 100 constructed in accordance with a preferred embodiment of the present invention is shown in FIG. 1. The disc drive 100 is to be operably connected to a host computer 140 in which the disc drive 100 is mounted in a conventional manner. Control communication paths are provided between the host computer 140 and a disc drive microprocessor 142, the microprocessor 142 generally providing top level communication and control for the disc drive 100 in conjunction with programming for the microprocessor 142 stored in microprocessor memory (MEM) 143. The MEM 143 can include random access memory (RAM), read only memory (ROM) and other sources of resident memory for the microprocessor 142.

Data is transferred between the host computer 140 and the disc drive 100 by way of a disc drive interface 144, which typically includes a buffer to facilitate high speed data transfer between the host computer 140 and the disc drive 100. Data to be written to the disc drive 100 are thus passed from the host computer to the interface 144 and then to a read/write channel 146, which encodes and serializes the data and provides the requisite write current signals to the heads 118. To retrieve data that has been previously stored by the disc drive 100, read signals are generated by the heads 118 and provided to the read/write channel 146, which performs decoding and error detection and correction operations and outputs the retrieved data to the interface 144 for subsequent transfer to the host computer 140.

The discs are rotated at a constant high speed by a spindle control circuit 148, which typically electrically commutates the spindle motor. During a seek operation, the track position of the heads 118 is controlled through the application of current to the coil 126 of the actuator assembly 110. A servo control circuit 150 provides such control.

During a seek operation the microprocessor 142 receives information regarding the velocity and acceleration of the head 118, and uses that information in conjunction with a model, stored in memory 143, of the plant to generate the response of the servomechanism to a high frequency stimulus to communicate with the servo control circuit 150, which will apply a controlled amount of current to the voice coil motor 126, thereby causing the actuator assembly 110 to be pivoted.

The track position of the heads 118 is controlled through the use of a voice coil motor (VCM) 124, which typically includes a coil 126 attached to the actuator assembly 110, as well as one or more permanent magnets 128 which establish a magnetic field in which the coil 126 is immersed. The controlled application of current to the coil 126 causes magnetic interaction between the permanent magnets 128 and the coil 126 so that the coil 126 moves in accordance with the well-known Lorentz relationship. As the coil 126 moves, the actuator assembly 110 pivots about the bearing shaft assembly 112, and the heads 118 are caused to move across the surfaces of the discs 108.

Whenever the magnetic flux through the coil 126 changes, a voltage across the coil 126 is developed, so as to oppose the change in magnetic flux. This voltage is known as “back electromotive force” or “back EMF”. There are two ways that the magnetic flux through the coil 126 can change: (1) the current running through the coil 126 changes; or (2) the coil 126 moves across the magnetic field. Assuming steady-state conditions, the current through the coil 126 remains constant as the coil 126 is accelerated and decelerated, thus the predominant source of back EMF in the coil 126 is due to motion of the coil itself.

FIG. 2 depicts a model of the voice coil motor 124, accounting for back EMF due to the motion of the coil. As can be seen in FIG. 2, the voice coil motor 124 is characterized by a coil resistance 200 and a coil inductance 202. When the head 118 to which the voice coil motor 124 is attached is in motion, i.e., the voice coil motor is rotated around a pivot, the voice coil motor 124 exhibits a back EMF 204. The back EMF 204 is in proportion to the change in magnetic flux through the coil, which is, in turn, in approximate proportion to the velocity of the head 118 to which the voice coil motor 124 is attached. Thus, the back EMF 204 exhibited by the voice coil motor 124 can be multiplied by a gain value that characterizes the motor, thereby yielding the velocity of the read/write head 118. Since the integral of velocity is displacement, the position of the read/write head 118 may be determined by integrating the velocity—itself determined from the back EMF—and accounting for the initial position of the read/write head 118.

The back EMF 204 can be measured indirectly. In determining the back EMF 204, V_{bEMF}, first, the voltage across both the voice coil motor 124 and an associated current-sensor resistor 206, Vₘ, is determined. Next, from this quantity, the voltage across the current-sensor resistor 206, V_{RS}, and the voltage across the characteristic coil resistance 200, V_{Rm}, are subtracted:

V_{bEMF}=Vₘ−V_{RS}−V_{Rm}

FIG. 3 is a signal flow diagram depicting the steps by which a disc drive may be controlled, using the back EMF 204 of the voice coil motor 124 as the basis for determining head velocity and head position. Upon power-up, the read/write head 118 is parked upon a parking zone (thus, its initial position is known). As a part of the power-up routine, the read/write head 118 is to move to a median track location between the inner and outer diameter of the disc. During this period, the servo control system will obtain head speed and position information based upon back EMF of the voice coil motor 124.

The discussion now turns to disclosing a control system/control method for controlling the position of the read/write head based upon knowledge of estimated head speed and an estimated head displacement from a target position. The immediate discussion assumes the availability of estimated head velocity and estimated head displacement from a target position. In the following discussion, this disclosure will reveal how to obtain these values based upon the back EMF of the voice coil motor. Initially, in a look-up operation/module 300, a reference head velocity, V_{ref}, is obtained up from a look-up table, using estimated displacement from the target position, ₑₛₜ, as an index (the process of arriving at the estimated displacement from the target position is discussed below). Next, in a subtraction operation/module 302, the reference head velocity looked up in the look-up operation/module 300 is used as a minuend from which an estimated head velocity value is subtracted (the process of arriving at the estimated head velocity is discussed below). Thus, the resultant difference yielded by the subtraction operation/module 302 represents the difference between the desired velocity of the read/write head and its estimated velocity (this is also known as the “velocity error”). The velocity error determined by the subtraction operation/module 302 is utilized by a velocity loop controller operation/module 304. The velocity loop controller operation/module 304 produces a control signal that is based upon the velocity error and a running integral thereof, which can easily be implemented by those of skill in the art. In one possible embodiment, the velocity loop controller operation/module 304 produces the control signal by multiplying the velocity error by a first factor, multiplying the integral of the velocity error by a second factor, and adding the two products together. The control signal yielded by the velocity loop controller operation/module 304 is converted to an analog control signal in an analog conversion operation/module 306. The analog control signal represents a desired current level to be driven through the voice coil motor. In a subtraction operation/module 308, the analog control signal is used as a minuend from which a signal representing the actual current level of the coil is subtracted. Thus, the resultant difference yielded by the subtraction operation/module 308 represents the difference between the desired coil current level and the actual coil current level (this is also known as the “current command error”). The current command error is utilized in a transconductance amplifier compensation operation/module 310. The transconductance amplifier compensation operation/module 310 receives the current command error and determines a correct output voltage (Vₘ), which is applied across the voice coil motor, thereby driving current through the voice coil motor and driving the current command error to zero. Next, in a current sensor module/operation 312, the current driven through the voice coil motor is detected and represented as a voltage. This voltage is supplied to the subtraction operation/module 308 (as mentioned above) and used as a subtrahend, being subtracted from the desired current level in order to produce the current command error.

The above discussion revealed a control system that assumed the availability of: (1) data representing estimated head velocity; and (2) data representing the estimated displacement from the target position. The discussion now turns to a method and apparatus for determining the aforementioned data items, based upon the back EMF of the voice coil motor. As stated earlier, the back EMF of the voice coil motor is approximately proportional to the velocity of the coil (and therefore approximately proportional to the velocity of the read/write head, which is attached to the actuator arm at the opposite end of the coil). Thus, estimated head velocity may be arrived at simply by finding the back EMF of the voice coil motor. Estimated head displacement from a target position may be found by integrating the estimated head velocity (i.e., integrating the back EMF). As was also stated earlier, the general scheme for finding the back EMF of the voice coil motor, V_{bEMF}, is to first find the voltage across the voice coil motor 124 and an associated current-sensor resistor 206, Vₘ, and to then subtract therefrom the combined voltage across the current-sensor resistor 206, V_{RS}, and the characteristic coil resistance 200, V_{Rm}:

V_{bEMF}=Vₘ−V_{RS}−V_{Rm}

As can be seen in FIG. 3, the combined voltage across the current-sensor resistor 206, V_{RS}, and the characteristic coil resistance 200, V_{Rm} is obtained in a resistance multiplication operation/module 314. The resistance multiplication operation/module 314 multiplies the current driven through the voice coil motor by the combined resistance of the current-sensor resistor 206 and the characteristic coil resistance 200, thereby yielding the voltage thereacross. In a subtraction operation 316, the combined voltage across the voice coil motor and the current-sensor resistor 206 is used as a minuend from which the combined voltage determined in the resistance multiplication operation/module 314 is subtracted. Thus, the difference resulting from the subtraction operation 316 represents the back EMF of the voice coil motor, which is representative of the velocity of the read/write head. Accordingly, the back EMF is made available as an input to the subtraction operation/module 302 via the use of a digital conversion operation/module 318. The back EMF is integrated in an integration operation/module 320, thereby yielding the estimated displacement from the target position, which is then supplied to the look-up operation/module 300, thereby completing the control loop.

FIG. 4 depicts an embodiment of a control system effectuating the control operations and modules depicted in FIG. 3. The control system 400, consists of a microprocessor, 402, a digital-to-analog converter 404, a first summer 406, a transconductance amplifier compensator 408, a voice coil motor driver 410, a voice coil motor 412, a current-sensor resistor 414, a first differential amplifier 416 a second differential amplifier 418, a voice coil motor coil resistance estimator amplifier 420, a second summer 422, and an analog-to-digital converter 424. The microprocessor 402 embodies certain modules/operations depicted in FIG. 3. Specifically, the microprocessor 402 embodies the look-up operation/module 300, the subtraction operation/module 302, the velocity loop controller operation/module 304, and the integration operation/module 320. The microprocessor 402 performs the functions and purposes discussed (in the discussion associated with FIG. 3) with respect to the operations/modules it embodies. The digital-to-analog converter 404 embodies the analog conversion operation/module 306, and performs its functions and purposes as discussed in the passages associated with FIG. 3. The analog-to-digital converter 424 embodies the digital conversion operation/module 318, and performs its functions and purposes as discussed in the passages associated with FIG. 3. Optionally, the digital-to-analog converter 404 and the analog-to-digital converter 424 may be embodied within the circuitry of the microprocessor 402. The first summer 406 embodies the subtraction operation/module 308, and performs its functions and purposes as discussed in the passages associated with FIG. 3. The transconductance amplifier compensator 408 and the voice coil motor driver 410 jointly embody the transconductance amplifier compensation operation/module 310, and jointly perform its functions and purposes as discussed in the passages associated with FIG. 3. The current-sensor resistor 414 and the first differential amplifier 416 jointly embody the current sensor module/operation 312. As shown in FIG. 4, the current-sensor resistor 414 is connected in series with the voice coil motor 412. Thus, the electrical current passing through the voice coil motor 412 also passes through the current-sensor resistor 414. The first differential amplifier 416 detects the voltage across the current-sensor resistor 414, thereby representing the current through the voice coil motor as a voltage. The voice coil motor coil resistance estimate amplifier 420, the current-sensor resistor 414, and the first differential amplifier 416 jointly embody the resistance multiplication operation/module 314. The voice coil motor coil resistance estimate amplifier 420 receives the voltage level from the first differential amplifier 416 and amplifies it by a gain factor that has been determined to model the resistance characterizing the voice coil motor coil resistance, thereby yielding a voltage that is added to the voltage produced by the first differential amplifier. Stated another way, the output of the voice coil motor coil resistance estimate amplifier 420 is the combined voltage across the current-sensor resistor 414 and the characteristic coil resistance. The second differential amplifier 418 detects the combined voltage across the voice coil motor and the current-sensor resistor 414, and supplies that voltage to the second summer 422. Finally, the second summer 422 embodies subtraction operation 316, and performs its functions and purposes as discussed in the passages associated with FIG. 3.

To summarize preferred embodiments of the present invention, an apparatus for determining the position of a read/write head in a disc drive based upon knowledge of the starting position of the read/write head and the level of back EMF in the voice coil motor consists of the following. A voice coil motor (such as 412) along with means for estimating for estimating a position of the read/write head based upon the back electromotive force (such as 400) and an actuator arm (such as 110) along with a means for determining a reference velocity of the read/write head (such as in operation 300) and a means for determining a velocity error (such as in operation 302), based upon the reference velocity of the read/write head and upon the estimated speed of the read/write head and a means for controlling motion of the read/write head (such as in operation 310). The means for estimating a position of the read/write head based upon the back electromotive force may further comprise a means for estimating a speed of the read/write head (such as in operation 316) and a means for integrating the estimated speed (such as in operation 320), thereby yielding the position of the read/write head. The means for estimating a speed of the read/write head may further comprise a means for estimating the back electromotive force across the voice coil motor (such as in operation 316).

The velocity and position of a read/write head may be arrived at, based upon the back EMF of the voice coil motor in a disc drive, by performing the following steps. Determine the voltage across the voice coil motor (such as in operation 310). Additionally, determine the voltage across the current-sensor resistor (such as in operation 312). The voltage across the current-sensor resistor may be measured with a differential amplifier. Also, determine the coil resistance voltage (such as in operation 314). The coil resistance may be determined by measuring the voltage across the current-sensor resistor with a differential amplifier and amplifying the voltage across the current-sensor resistor by a gain value. Finally, subtract the combined voltage across the current-sensor resistor and the coil resistance voltage from the voltage across the voice coil motor, yielding the back EMF of the voice coil motor (such as in operation 316). Additionally, an additional set of steps may be performed. The back EMF of the voice coil motor may be integrated, yielding an integrated quantity, which is multiplied by a gain factor, thereby yielding an estimate of the read/write head position (such as in operation 320). Finally, a reference velocity may be looked up from a look-up table, using the estimate of the read/write head position as an index (such as in operation 300).

It will be clear that the present invention is well adapted to attain the ends and advantages mentioned as well as those inherent therein. While presently preferred embodiments have been described for purposes of this disclosure, numerous changes may be made which will readily suggest themselves to those skilled in the art and which are encompassed in the spirit of the invention disclosed and as defined in the appended claims.

What is claimed is:

1. A method of determining a speed and position of a read/write head in a disc drive, the disc drive comprising a voice coil motor to which the read/write head is attached and a current-sensor resistor electrically coupled in series with the voice coil motor, the voice coil motor being characterized by a coil resistance and a coil inductance, the coil resistance being characterized by a coil resistance voltage, the voice coil motor possessing a back electromotive force (back EMF) when the read/write head is in motion, the voice coil motor having a voltage across itself, the current-sensor resistor being characterized by a current-sensor resistor resistance, the current-sensor resistor conducting an electrical current, the current-sensor resistor having a voltage across itself when conducting the electrical current, the method comprising:
(a) estimating the voltage across the voice coil motor;
(b) estimating the voltage across the current-sensor resistor;
(c) estimating the coil resistance voltage;
(d) estimating the back EMF of the voice coil motor, based upon the voltage across the current-sensor resistor, the coil resistance voltage, and the voltage across the voice coil motor; and
(e) estimating the speed and position of the read/write head, based upon the back EMF of the voice coil motor.

2. The method of claim 1, wherein step (b) comprises measuring the voltage across the current-sensor resistor with a differential amplifier.

3. The method of claim 1, wherein step (c) comprises:
(c)(i) measuring the voltage across the current-sensor resistor with a differential amplifier;
(c)(ii) amplifying the voltage across the current-sensor resistor by a gain value, yielding the coil resistance voltage;

4. The method of claim 1, further comprising looking up a reference speed from a look-up table, using the estimate of the read/write head position as an index.

5. The method of claim 1, wherein step (d) comprises subtracting the voltage across the current-sensor resistor and the coil resistance voltage from the voltage across the voice coil motor, yielding the back EMF of the voice coil motor.

6. The method of claim 1, wherein step (e) comprises:
(e)(i) estimating speed based on its proportionality with the back EMF;
(e)(ii) integrating the back EMF of the voice coil motor, yielding an integrated quantity; and
(e)(iii) multiplying the integrated quantity by a gain factor, thereby yielding an estimate of a position of the read/write head.

7. A disc drive configured and arranged to estimate a position of a read/write head, the disc drive comprising:
a voice coil motor, the voice coil motor having a back electromotive force across itself when the read/write head is in motion; and
a means for estimating a position of the read/write head based upon the back electromotive force.

8. The disc drive of claim 7, wherein the means for estimating a position of the read/write head comprise:
a means for estimating a speed of the read/write head; and
a means for integrating the estimated speed, thereby yielding the position of the read/write head.

9. The disc drive of claim 8, wherein the means for estimating a speed of the read/write head comprises:
a means for estimating the back electromotive force across the voice coil motor.

10. The disc drive of claim 7, further comprising:
an actuator arm having a proximal and a distal end, the read/write head being disposed upon the distal end of the actuator arm; and
a means for determining a reference velocity of the read/write head, based upon the position of the read/write head.

11. The disc drive of claim 10, further comprising:
a means for determining a velocity error, based upon the reference velocity of the read/write head and upon the estimated speed of the read/write head.

12. The disc drive of claim 7, further comprising:
a means for controlling motion of the read/write head.
